(19) United States
(12) Patent Application Publication
(10) Pub. No.: US 2011/0309689 A1
(43) Pub. Date: Dec. 22, 2011

(54) ELECTRIC POWER TRANSMITTING DEVICE, ELECTRIC POWER RECEIVING DEVICE, AND POWER SUPPLY METHOD USING ELECTRIC POWER TRANSMITTING AND RECEIVING DEVICES

(75) Inventor: Koichiro KAMATA, Isehara (JP)

(73) Assignee: SEMICONDUCTOR ENERGY LABORATORY CO., LTD., Kanagawa-ken (JP)

(21) Appl. No.: 13/157,611

(22) Filed: Jun. 10, 2011

(30) Foreign Application Priority Data
Jun. 17, 2010 (JP) 2010-138112

(51) Int. Cl. H01F 38/14

(52) U.S. Cl. 307/104

(57) ABSTRACT

In electric power supply through wireless signals, electric power is supplied efficiently, even when distance fluctuation is caused between an electric power transmitting device and an electric power receiving device. Even when distance fluctuation is caused between the electric power transmitting device for supplying electric power with the use of wireless signals and the electric power receiving device for receiving electric power supplied from the electric power transmitting device, the Q value of the electric power transmitting device is adjusted to optimize the transmission efficiency. The impedance of a resonance circuit of the electric power transmitting device is fluctuated at a constant frequency, the resulting reflected wave is detected as a response signal by the electric power transmitting device, and the Q value of the electric power transmitting device is adjusted to optimize the transmission efficiency.

### BACKGROUND OF THE INVENTION

1. Field of the Invention

The present invention relates to an electric power transmitting device for supplying electric power through a wireless signal, an electric power receiving device, and a method for supplying electric power using the electric power transmitting device and the electric power receiving device.

In this specification, the semiconductor device refers to all types of devices which can function by utilizing semiconductor characteristics, and image capturing devices, display devices, electro-optical devices, electric power transmission devices, electric power receiving devices, semiconductor circuits, electronic devices, etc. are all categorized into semiconductor devices.

2. Description of the Related Art

In recent years, with the development of information communication technology, the realization of a ubiquitous society has been proposed in which a variety of electronic devices is connected to a computer network so that information can be exchanged freely and a variety of services can be achieved. The term “ubiquitous” comes from the Latin word meaning “existing or being everywhere” (being omnipresent), and means that information processing using computers is naturally woven into a living environment through electronic devices without any awareness of computers at anytime and anywhere.

In order to allow an electronic device to operate, electric power needs to be supplied to the electronic device (hereinafter, also referred to as “electric power transmission”). Electric Power is supplied by a built-in battery to a portable electronic device typified by a cellular phone, and the battery is charged in the following way: the electronic device is set in a battery charger such that the battery receives electric power from a commercial power source distributed to each house. In addition, while a contact needs to be provided in order to connect the electronic device and the battery charger, a non-contact power supply means (also referred to as a wireless power transmission technology) requiring no contact has been attracting attention, because of elimination of breakdown due to a defective contact, ease of a design provided with waterproof function, etc.

As the non-contact power supply means, an electromagnetic induction type, a magnetic field resonance type, an electric field resonance type, an electromagnetic wave (micro wave) method, etc. have been considered. In particular, the magnetic field resonance type has the features of a simple device configuration, no need to strictly adjust the locations of electric power transmission and reception sides, and capability of high-efficiency power transmission at a distance of several meters.

### [Reference]

### [Non-Patent Document]

### [Non-Patent Document 1]

“Wireless Power Transmission-Second Act”, EETIMES Japan, No. 51, October 2009, pp. 20-33

### SUMMARY OF THE INVENTION

In the magnetic field resonance type power transmission, antennas with the same resonance frequency are prepared respectively for an electric power transmitting device and an electric power receiving device, high-frequency power is supplied to the electric power transmission antenna to generate a magnetic field, and electric power is supplied through a resonance phenomenon to the electric power reception antenna with the same resonance frequency.

The magnetic field resonance type power transmission allows high-efficiency power transmission at a distance of several meters. However, the power transmission has a problem that, when the distance (power transmission distance) is fluctuated between the electric power transmission antenna and the electric power reception antenna, the fluctuation in mutual reactance significantly decreases the transmission efficiency (the ratio of electric power received by the electric power receiving device to electric power supplied by the electric power transmitting device).

In order to supply a certain amount of electric power to the electric power receiving side constantly, the amount of electric power supplied to the electric power transmitting side needs to be increased in response to the decreased transmission efficiency, thereby resulting in an increase in the power consumption of the electric power transmitting side.

While methods for improving the transmission efficiency include a method of changing power transmission frequency depending on fluctuation in mutual reactance and a method of adjusting the inductance L of the electric power transmission antenna, these method have a problem that there is a need to separately provide a mechanism for detecting the received power strength and a communication tool for returning the received power strength detected to the electric power transmitting device, thereby resulting in a complicated circuit configuration. Therefore, the number of components is increased, resulting in a problem of difficulty with improvement in productivity or with cost reduction.

An object of one embodiment according to the present invention is to provide a power supply device with its power consumption reduced.

Another object of one embodiment according to the present invention is to provide a power supply device with high productivity.

One embodiment according to the invention disclosed in this specification achieves at least one of the objects mentioned above.

The transmission efficiency between an electric power transmitting device for supplying electric power with the use of a wireless signal with a first frequency and an electric power receiving device for receiving electric power supplied from the electric power transmitting device is optimized by adjusting the Q value of the electric power transmitting device.

The electric power receiving device has a resonance circuit connected to a modulation circuit, and the modulation circuit fluctuates the impedance of the resonance circuit at a second frequency. The fluctuation of the impedance returns a reflected wave in which the first frequency and second frequency superimposed on each other to the electric power transmitting device. Since the magnitude of the amplitude of the reflected wave is inversely proportional to the distance between the electric power transmitting device and electric power receiving device, a modulated signal detection circuit included in the electric power transmitting device detects an amplitude component of the second frequency to adjust the Q value of the electric power transmitting device depending on the amplitude of the second frequency.

As the second frequency, a frequency is used which is different from the first frequency used for electric power supply by the electric power transmitting device. The second frequency is preferably a frequency smaller than the first frequency. It can be understood that the transmission efficiency is higher as the second frequency detected in the electric power transmitting device has an increased amplitude, whereas the transmission efficiency is lower as the second frequency has a decreased amplitude.

The Q value of the electric power transmitting device is adjusted appropriately while monitoring the change in the amplitude of the second frequency before and after changing the Q value. After increasing the Q value, the Q value is decreased if the second frequency detected in the electric power transmitting device has a decreased amplitude. Alternatively, after decreasing the Q value, the Q value is increased if the second frequency detected in the electric power transmitting device has a decreased amplitude.

While the Q value may be changed by using two levels of a maximum and a minimum for changing the Q value, the division into 5 or more levels, preferably 10 or more levels is preferable, because the transmission efficiency can be adjusted with a high degree of efficiency. In addition, a look-up table or the like may be used to determine the Q value according to a size of the amplitude of the second frequency detected in the electric power transmitting device.

According to an embodiment of the present invention, a power supply device can be advantageously provided which has reduced power consumption and transmits electric power efficiently.

According to an embodiment of the present invention, a power supply device can be advantageously provided which has fewer components with high productivity.

### BRIEF DESCRIPTION OF THE DRAWINGS

In the accompanying drawings:

FIGS. 1A and 1B are diagrams illustrating configuration examples of an electric power transmitting device and of an electric power receiving device;

FIGS. 2A and 2B are diagrams illustrating configuration examples of an electric power transmitting device;

FIGS. 3A and 3B are diagrams illustrating the configurations of an electric power transmitting device and an electric power receiving device used in a circuit simulation;

FIG. 4 is a diagram illustrating a calculation result in the circuit simulation;

FIG. 5 is a diagram illustrating changes in electric potential detected in the electric power transmitting device;

FIG. 6 is a flowchart for explaining an example of a method for adjusting the Q value of the electric power transmitting device;

FIGS. 7A and 7B are diagrams illustrating examples of utility forms of the electric power transmitting device and the electric power receiving device; and

FIGS. 8A and 8B are diagrams illustrating examples of utility forms of the electric power transmitting device and the electric power receiving device.

### DETAILED DESCRIPTION OF THE INVENTION

Embodiments of the present invention will be described below in detail with reference to the accompanying drawings. However, the present invention is not limited to the description below, and it is easily understood by those skilled in the art that modes and details disclosed herein can be modified in various ways without departing from the spirit and the scope of the present invention. Therefore, the present invention is not construed as being limited to description of the embodiments.

Note that the position, size, range, etc. of each structure illustrated in drawings and the like are not intended to refer to their actual positions, size, ranges, etc. in some cases for easy understanding. Therefore, the disclosed invention is not necessarily limited to the position, size, range, or the like as disclosed in the drawings and the like. Through the drawings for explaining the embodiments, the same sections or sections having a similar function are denoted by the same reference numerals, and description of such sections will not be repeated.

In this specification and the like, the term such as “electrode” or “wiring” is not intended to limit the components functionally. For example, the term “electrode” may be used as a part of a “wiring” in some cases, and vice versa. Furthermore, the term “electrode” or “wiring” include a case in which a plurality of “electrodes” or “wirings” is formed in an integrated manner.

A transistor is a type of semiconductor element, and can achieve amplification of a current or a voltage, a switching operation for controlling conduction or non-conduction, etc. The transistor in this specification includes an insulated gate field effect transistor (IGFET) and a thin film transistor (TFT).

Note that in this specification and the like, since a source and a drain of a transistor may be interchanged depending on the structure, operating condition, etc. of the transistor, it is difficult to define which is a source or a drain. Therefore, the terms “source” and “drain” can be switched in this specification and the like.

In this specification and the like, ordinal numbers such as “first”, “second”, and “third” are used in order to avoid confusion among components, and the terms are not intended to limit the components numerically.

### Embodiment 1

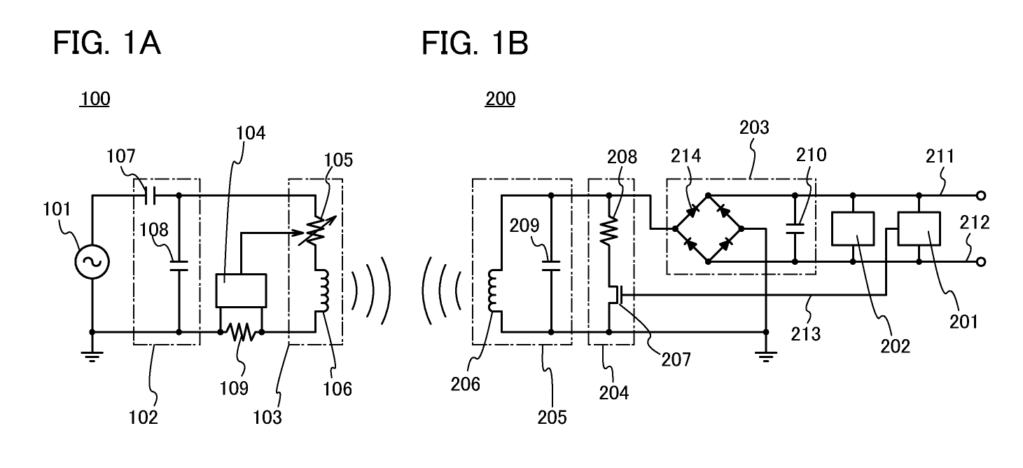

In the present embodiment, one aspect according to the present invention will be described with reference to FIGS. 1A and 1B, FIGS. 2A and 2B, FIGS. 3A and 3B, FIG. 4, and FIG. 5.

An electric power transmitting device 100 shown in FIG. 1A includes a power source 101, a matching circuit 102, an electric power radiation circuit 103, a modulated signal detection circuit 104, and a resistive element 109. The matching circuit 102 includes a capacitative element 107 connected in series to the power source 101, and a capacitative element 108 connected in parallel to the power source 101.

The power source 101 generates alternating-current power, and supplies the alternating-current power through the matching circuit 102 to the electric power radiation circuit 103. The frequency f_{G} of the alternating-current power supplied by the power source 101 is not limited to a specific frequency, and for example, any of the following frequencies can be used: 300 GHz to 3THz as frequencies of sub-millimeter waves; 30 GHz to 300 GHz as frequencies of millimeter waves; 3 GHz to 30 GHz as frequencies of microwaves; 300 MHz to 3 GHz as frequencies of ultrashort waves; 30 MHz to 300 MHz as frequencies of ultrashort waves; 3 MHz to 30 MHz as frequencies of short waves; 300 kHz to 3 MHz as frequencies of medium waves; 30 kHz to 300 kHz as frequencies of long waves; and 3 kHz to 30 kHz as frequencies of ultralong waves.

It is to be noted that if there is a difference between the impedance of the power source 101 and the impedance of the electric power radiation circuit 103, the alternating-current power supplied from the power source 101 is partially reflected in response to the difference in impedance, and the alternating-current power is thus not able to be supplied efficiently to the electric power radiation circuit 103. The matching circuit 102 has the function of substantially matching the impedance of the power source 101 with the impedance of the electric power radiation circuit 103, and efficiently transmitting to the electric power radiation circuit 103, the alternating-current power supplied from the power source 101.

The electric power radiation circuit 103 includes an electric power transmission antenna 106 and a variable resistive element 105, and has the function of radiating the alternating-current power with the frequency f_{G} supplied from the power source 101 through the electric power transmission antenna 106 to the external space.

The resistive element 109 is connected in series between the electric power transmission antenna 106 and the power source 101. The modulated signal detection circuit 104 is connected in parallel to the resistive element 109, and has the function of detecting the fluctuation in electric potential of the resistive element 109.

An electric power receiving device 200 shown in FIG. 1B includes a resonance circuit 205, a modulation circuit 204, a rectifier circuit 203, a regulator 202, and a logic circuit 201. The resonance circuit 205 includes an electric power reception antenna 206 and a capacitative element 209. In addition, the resonance circuit 205 has a resonance frequency f_{R} which is determined by the combination of the inductance L of the electric power reception antenna 206 and the conductance C of the capacitative element 209.

The frequency f_{G} of the alternating-current power radiated from the electric power radiation circuit 103 is matched with the resonance frequency f_{R} of the resonance circuit 205 to allow the resonance circuit 205 to generate an induced electromotive force in accordance with the Faraday's laws of electromagnetic induction and allow power supply to be achieved from the electric power transmitting device 100 to the electric power receiving device 200.

The modulation circuit 204 includes a transistor 207 and a resistive element 208, and is connected in parallel to the resonance circuit 205. For the semiconductor for use in the transistor 207, amorphous semiconductors, microcrystalline semiconductors, polycrystalline semiconductors, etc. can be used. For example, amorphous silicon or microcrystalline germanium can be used. In addition, oxide semiconductors and compound semiconductors such as SiC can be also used.

The rectifier circuit 203 includes a diode 214 and a capacitative element 210, and is connected to a wiring 211 and a wiring 212. The rectifier circuit 203 has the function of converting alternating-current power induced in the resonance circuit 205 to direct-current power, and supplying the direct-current power to the wiring 211 and the wiring 212. The regulator 202 is connected in parallel to the wiring 211 and the wiring 212, and has the function of adjusting the electric potential difference between the wiring 211 and the wiring 212 so as not to exceed a certain value. The regulator 202 prevents any excessive voltages from being applied to the logic circuit 201 connected to the wiring 211 and the wiring 212, and to other circuits, not shown.

The logic circuit 201 is connected in parallel to the wiring 211 and the wiring 212, and connected through a wiring 213 to a gate of the transistor 207 included in the modulation circuit 204.

While the electric power transmission antenna 106 and the electric power reception antenna 206 each have a coil shape in the present embodiment, the shapes of the antennas are not limited thereto, and may be determined as appropriate in consideration of the frequency of a high-frequency wave for use in supplying electric power. Instead of a coiled antenna, a monopole antenna, a dipole antenna, a patch antenna, etc. can be used.

The power transmission efficiency is determined by the product of a k value and a Q value. The k value is also referred to as a coupling coefficient k, which is an index indicating the strength of coupling between the electric power transmission antenna 106 and the electric power reception antenna 206, and represented by the following FORMULA 1.

[FORMULA 1]

k=M\sqrt{L_{G}×L_{R}} FORMULA 1

L_{G} represents the inductance of the electric power transmission antenna 106, and L_{R} represents the inductance of the electric power reception antenna 206. M represents mutual inductance. The coupling coefficient k has a smaller value, as the distance between the electric power transmission antenna 106 and the electric power reception antenna 206 (the antenna-to-antenna distance) is increased.

The Q value is an index indicating energy retained by the electric power transmission antenna 106, and represented by the following FORMULA 2.

$$\begin{matrix}[ FORMULA 2 ] & \\ Q = \frac{2 π \times {f}_{G} \times {L}_{G}}{{R}_{ohm} + {R}_{rad}} & FORMULA 2\end{matrix}$$

F_{G} represents the frequency of the alternating-current power radiated from the electric power radiation circuit 103, L_{G} represents the inductance of the electric power transmission antenna 106, Rₒₕₘ represents a resistance component of the electric power radiation circuit 103, and R_{rad} represents a resistance component (radiation resistance) contributing to the radiation.

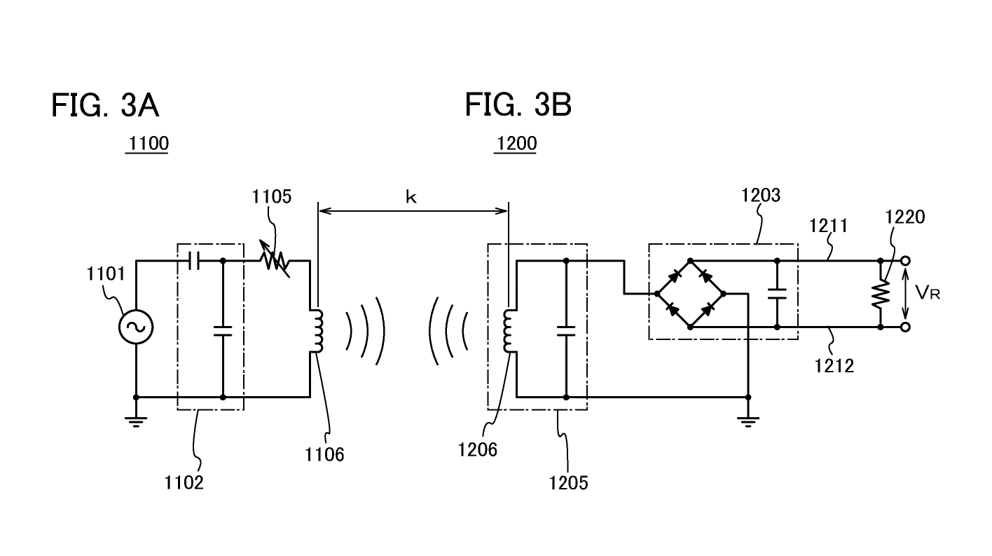

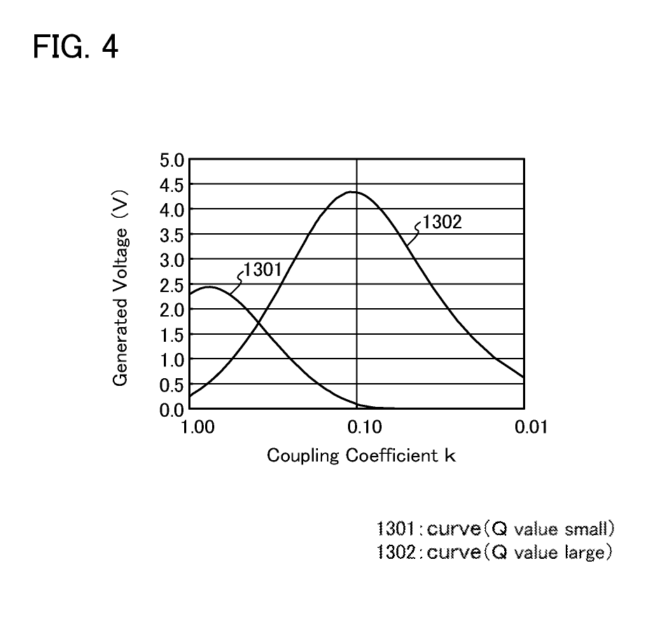

When the distance between the electric power transmission antenna 106 and the electric power reception antenna 206 is increased, the coupling coefficient k (k value) is decreased significantly. Thus, the transmission efficiency needs to be increased by increasing the Q value. Now, the relationship between the coupling coefficient k (antenna-to-antenna distance) and the a generated voltage in the case of changing a Q value calculated with a circuit simulation will be described with reference to FIGS. 3A and 3B and FIG. 4. The circuit simulation was carried out with the use of the software “SmartSpice” from SILVACO.

FIG. 3A shows a circuit configuration of an electric power transmitting device 1100 assumed for the calculation. The electric power transmitting device 1100 includes a power source 1101, a matching circuit 1102, and an electric power transmission antenna 1106. FIG. 3B shows a circuit configuration of an electric power receiving device 1200 assumed for the calculation. The electric power receiving device 1200 includes a resonance circuit 1205 with an electric power transmission antenna 1206, and a rectifier circuit 1203. The electric power receiving device 1200 is configured such that the rectifier circuit 1203 converts an induced electromotive force generated in the resonance circuit 1205 to direct-current power, and outputs the direct-current power as a generated voltage V_{R} to a load resistive element 1220 provided between a wiring 1211 and a wiring 1212.

The impedance of the power source 1101 was assumed to be 50 Ω, and the alternating-current power output from the power source 1101 was assumed to have a frequency of 13.56 MHz and an amplitude of 3V. With the assumption of 820Ω for the load resistive element 1220 between the wiring 1211 and the wiring 1212, the generated voltage V_{R} was calculated which was generated between the wiring 1211 and the wiring 1212 by receiving electric power.

FIG. 4 shows the simulation result. The horizontal axis in FIG. 4 indicates a coupling coefficient k, which corresponds to the antenna-to-antenna distance. The coupling coefficient has a smaller value, as the antenna-to-antenna distance is increased. The vertical axis indicates a generated voltage V_{R}, which shows that the transmission efficiency is higher as the value of the generated voltage V_{R} is increased. A curve 1301 shows the relationship between the coupling coefficient k and the generated voltage V_{R} in the case of 100Ω for the value of a variable resistive element 1105, whereas a curve 1302 shows the relationship between the coupling coefficient k and the generated voltage V_{R} in the case of 1Ω for the value of the variable resistive element 1105. In other words, the curve 1301 shows the relationship between the antenna-to-antenna distance and the transmission efficiency in the case of a smaller Q value, whereas the curve 1302 shows the relationship between the antenna-to-antenna distance and the transmission efficiency in the case of a larger Q value.

From FIG. 4, it is determined that an appropriate Q value is determined depending on the antenna-to-antenna distance. More specifically, the Q value of the electric power radiation circuit 103 included in the electric power transmitting device 100 can be adjusted to an appropriate value depending on the antenna-to-antenna distance to improve the transmission efficiency and achieve electric power transmission with lower power consumption.

In general, in order to detect the distance between an electric power transmitting device and an electric power receiving device and adjust the output power and the Q value depending on the detected distance, there is a need to use a signal with a different frequency from the frequency for use in electric power transmission, and a different communication tool. For this reason, there is a need to provide a communication section separately from the electric power transmission, thereby resulting in complexity of device configuration or difficulty with improvement in productivity or with cost reduction.

The use of the configuration disclosed in this specification can adjust, in the simple circuit configuration, the Q value of the electric power radiation circuit 103 with a high degree of accuracy, thus allowing an electric power transmitting device with lower power consumption and with a higher transmission efficiency to be manufactured with higher productivity. More specifically, power supply can be achieved with lower power consumption and with higher efficiency.

Subsequently, the operations of the electric power transmitting device 100 and electric power receiving device 200 disclosed in this specification will be described. The electric power transmitting device 100 and electric power receiving device 200 disclosed in this specification have a configuration in which the modulation circuit 204 included in the electric power receiving device 200 fluctuates the impedance of the electric power receiving device 200 at a frequency fₐₙₛ lower than the resonance frequency f_{R} to generate a reflected wave with the frequency fₐₙₛ as a response signal in the electric power transmitting device 100.

The modulation of the impedance carried out by the modulation circuit 204 is controlled by the logic circuit 201. The logic circuit 201 turns the transistor 207 on or off through the wiring 213. When the transistor 207 is turned on, a conduction state is provided between a source and a drain of the transistor 207 to decrease the internal resistance of the modulation circuit 204. When the transistor 207 is turned off, an insulation state is provided between the source and drain of the transistor 207 to increase the internal resistance of the modulation circuit 204. The logic circuit 201 can switch the transistor 207 between the on state and the off state to fluctuate the impedance of the electric power receiving device 200.

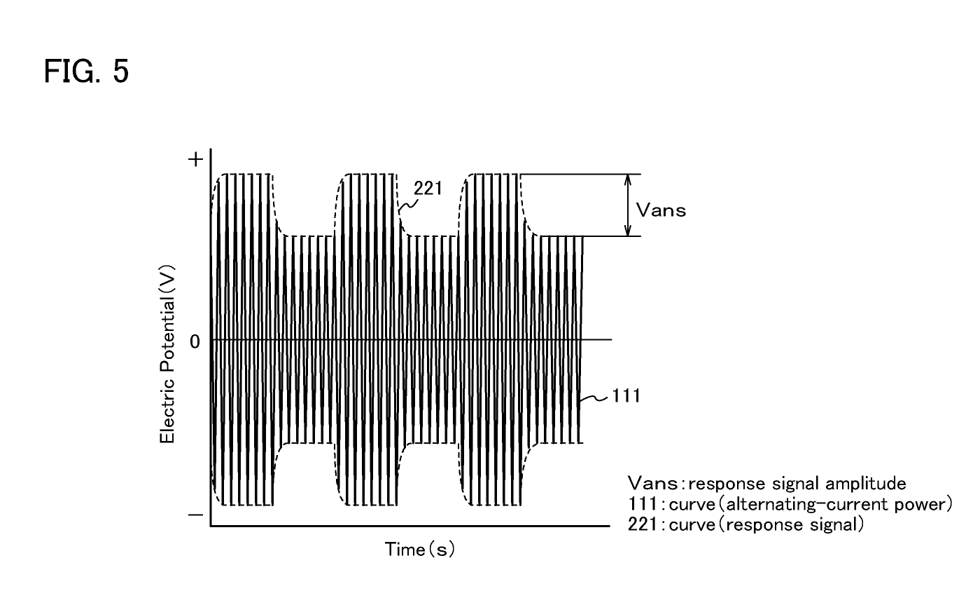

FIG. 5 shows changes in electric potential detected by the resistive element 109 included in the electric power transmitting device 100. In FIG. 5, the horizontal axis indicates time, whereas the vertical axis indicates an electric potential. The resistive element 109 detects an electric potential of a response signal 221 superimposed on alternating-current power 111 supplied from the power source 101. The response signal amplitude Vₐₙₛ refers to the electric potential amplitude of the response signal 221, which fluctuates depending on the k value, that is, the antenna-to-antenna distance. The response signal amplitude Vₐₙₛ is increased as the k value is increased (the antenna-to-antenna distance is decreased), and decreased as the k value is decreased (the antenna-to-antenna distance is increased).

The response signal amplitude Vₐₙₛ is detected by the modulated signal detection circuit 104 connected in parallel to the resistive element 109, and the resistance value of the variable resistive element 105 is adjusted depending on the response signal amplitude Vₐₙₛ. The variable resistive element 105 corresponds to Rₒₕₘ in FORMULA 2, and the resistance value of the variable resistive element 105 can be adjusted to provide an appropriate value for the Q value of the electric power radiation circuit 103. It is to be noted that the maximum value of the response signal amplitude Vₐₙₛ can be determined by the resistance value of the resistive element 208 included in the modulation circuit 204.

In this way, an appropriate Q value can be set for the electric power transmitting device 100, depending on the antenna-to-antenna distance.

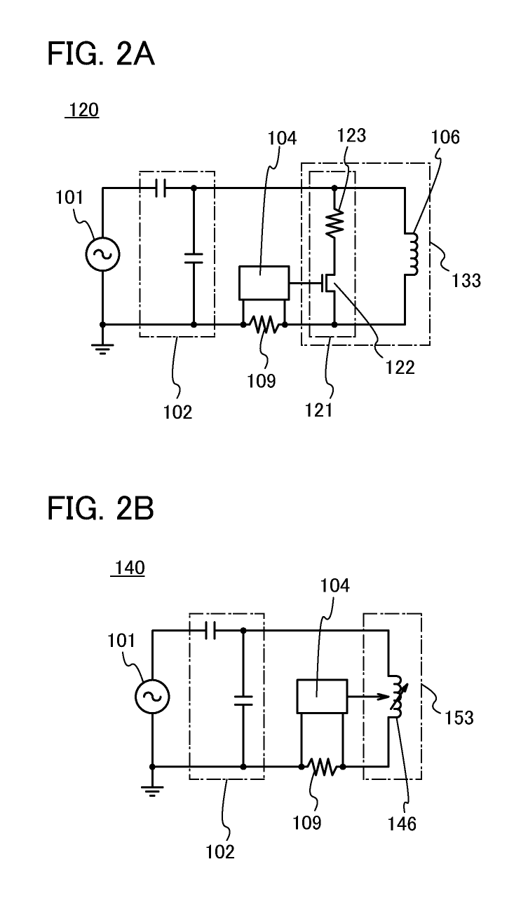

FIGS. 2A and 2B respectively show the configurations of an electric power transmitting device 120 and an electric power transmitting device 140, which have different configurations from the electric power transmitting device 100. In the electric power transmitting device 120 shown in FIG. 2A, an electric power radiation circuit 133 includes a Q value conditioning circuit 121 connected in parallel to an electric power transmission antenna 106. The Q value conditioning circuit 121 includes a transistor 122 and a resistive element 123, and the transistor 122 has a gate connected to a modulated signal detection circuit 104. The modulated signal detection circuit 104 can adjust the gate voltage of the transistor 122 to regulate the internal resistance of the Q value conditioning circuit 121. More specifically, the Rₒₕₘ in FORMULA 2 can be regulated to fluctuate the Q value of the electric power transmitting device 120.

The electric power transmitting device 140 shown in FIG. 2B is an example of using an antenna with variable inductance for an electric power transmission antenna 146 included in an electric power radiation circuit 153. A modulated signal detection circuit 104 changes the inductance of the electric power transmission antenna 146, thereby allowing the Q value to be adjusted. However, when the inductance of the electric power transmission antenna is changed, the adjustment of a matching circuit 102 may be necessary in some cases. In addition, when the number of coils or size of the antenna is changed, the Rₒₕₘ and R_{rad} in FORMULA 2 will also be affected. Thus, as illustrated by the examples in FIGS. 1A and 2A, the value of Rₒₕₘ is more preferably changed to adjust the Q value.

In addition, in the case of transmitting electric power to a plurality of electric power receiving devices 200, the frequency of a response signal generated in the logic circuit 201 and the modulation circuit 204 can also be set individually for each electric power receiving device 200 to indentify which electric power receiving device 200 is subjected to electric power transmission.

The present embodiment can be implemented in combination with other embodiments as appropriate.

### Embodiment 2

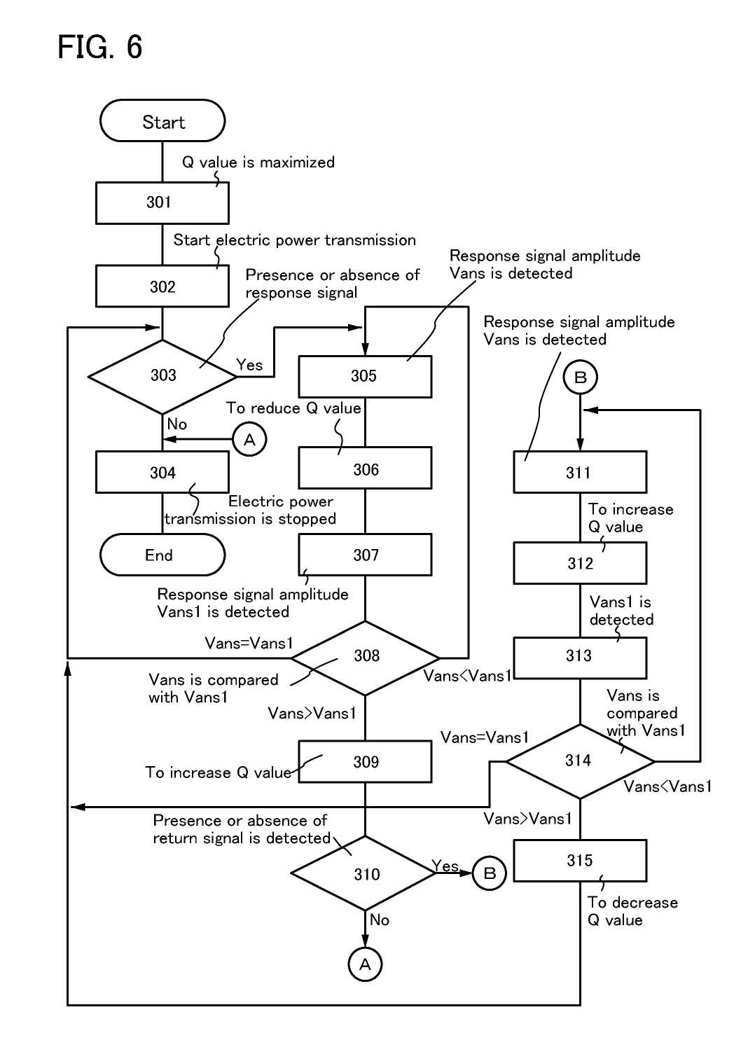

In the present embodiment, power supply through the electric power transmitting device 100 described in Embodiment 1, and an example of a method for adjusting the Q value of the electric power transmitting device 100 will be described with reference to a flowchart in FIG. 6.

First, the resistance value of the variable resistive element 105 included in the electric power transmitting device 100 is set to a minimum value so that the Q value is maximized (processing 301). Next, power is supplied from the power source 101 to the electric power radiation circuit 103 to start electric power transmission (processing 302). Next, the modulated signal detection circuit 104 detects the presence or absence of a response signal from the electric power receiving device 200 (determination 303). If no response signal is detected, the electric power transmission is stopped because there is a high possibility that the electric power receiving device 200 is not present, or receives no electric power (processing 304). However, electric power may continue to be transmitted at the discretion of the user. If a response signal is detected, a response signal amplitude Vₐₙₛ is detected (processing 305).

The variable resistive element 105 is allowed to function so as to indicate a number of different resistance values depending on the output of the modulated signal detection circuit 104. For example, the resistance value of the variable resistive element 105 may be divided into 10 levels depending on the output of the modulated signal detection circuit 104 to allow the variable resistive element 105 to function so as to indicate the 11 levels of resistance values, or subjected to no particular division to allow the variable resistive element 105 to function so as to indicate the 2 levels of resistance values of the minimum value and the maximum value. The number of divisions for the resistance value of the variable resistive element 105 is not particularly limited, and the Q value can be set with a higher degree of accuracy with a larger number of divisions. The number of divisions for the resistance value of the variable resistive element 105 is preferably 5 or more, and more preferably 10 or more.

After detecting the response signal amplitude Vₐₙₛ, the resistance value of the variable resistive element 105 included in the electric power transmitting device 100 is by one level increased to reduce the Q value (processing 306). Next, a response signal amplitude Vₐₙₛ₁ is detected (processing 307).

Next, the response signal amplitude Vₐₙₛ is compared in magnitude with the response signal amplitude Vₐₙₛ₁ (determination 308). If the response signal amplitude Vₐₙₛ₁ is larger than the response signal amplitude Vₐₙₛ, the processing is carried out in order from the processing 305 again. If the response signal amplitude Vₐₙₛ is equal to the response signal amplitude Vₐₙₛ₁, the processing is returned to the determination 303 to continue the processing. If the response signal amplitude Vₐₙₛ₁ is smaller than the response signal amplitude Vₐₙₛ, the resistance value of the variable resistive element 105 included in the electric power transmitting device 100 is decreased by one level to increase the Q value (processing 309).

Next, the presence or absence of a return signal is detected (determination 310), and if no return signal is detected, the electric power transmission is stopped (processing 304). However, electric power may continue to be transmitted at the discretion of the user. If a response signal is detected, a response signal amplitude Vₐₙₛ is detected (processing 311). Next, the resistance value of the variable resistive element 105 included in the electric power transmitting device 100 is decreased by one level to increase the Q value (processing 312). Next, a response signal amplitude Vₐₙₛ₁ is detected (processing 313).

Next, the response signal amplitude Vₐₙₛ is compared in magnitude with the response signal amplitude Vₐₙₛ₁ (determination 314). If the response signal amplitude Vₐₙₛ₁ is larger than the response signal amplitude Vₐₙₛ, the processing for increasing the Q value is carried out in order from the processing 311 again. If the response signal amplitude Vₐₙₛ is equal to the response signal amplitude Vₐₙₛ₁, the processing is returned to the determination 303 to continue the processing. If the response signal amplitude Vₐₙₛ₁ is smaller than the response signal amplitude Vₐₙₛ, the resistance value of the variable resistive element 105 included in the electric power transmitting device 100 is increased by one level to decrease the Q value (processing 315). After that, the processing is returned to the determination 303 to continue the processing.

Detecting the magnitude of the response signal amplitude Vₐₙₛ in this way allows the Q value of the electric power device 100 to be adjusted to supply electric power efficiently. While the one-level increase or decrease in the resistance value of the variable resistive element 105 has been described in the present embodiment, the resistance value may be increased or decreased by multiple levels. In addition, a look-up table or the like may be used to determine the amount of change in Q value as a function of the electric potential difference between the response signal amplitude Vₐₙₛ and response signal amplitude Vₐₙₛ₁.

The present embodiment can be implemented in combination with other embodiments as appropriate.

### Embodiment 3

Examples of moving objects according to one embodiment of the present invention include moving means driven by an electric motor using electric power accumulated in a secondary battery, such as automobiles (automatic two-wheeled vehicles, three or more-wheeled automobiles), motorized bicycles including motor-assisted bicycles, aircrafts, ships, and railroad cars.

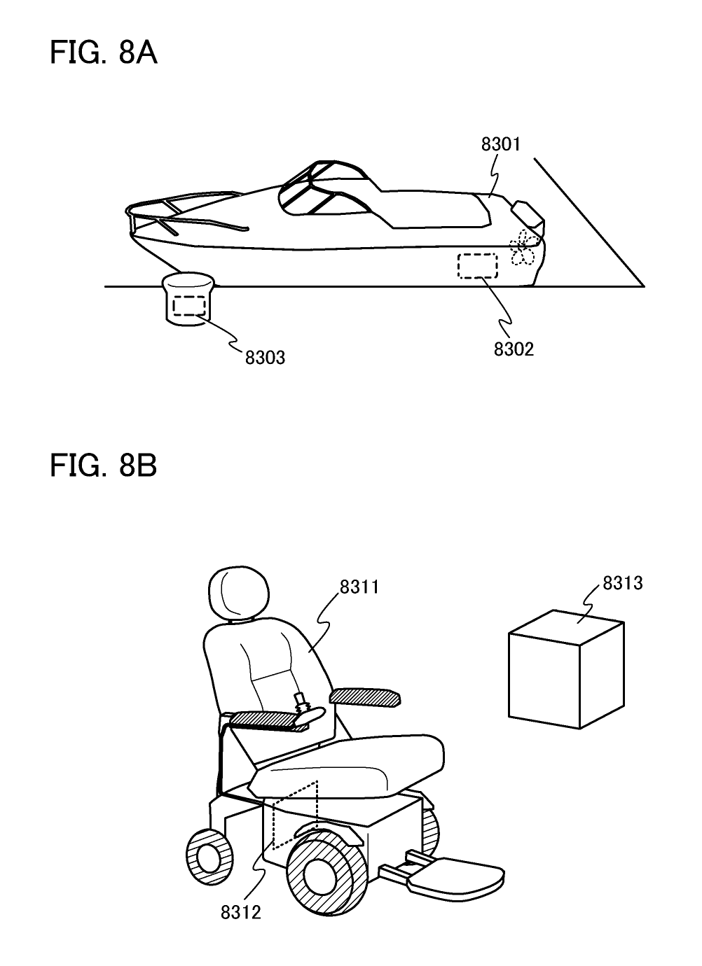

FIG. 8A shows a configuration of a motor boat 8301 as one of moving objects according to the present invention. FIG. 8A illustrates, as an example, a case of the motor boat 8301 including in its hull an electric power receiving device 8302. An electric power transmitting device 8303 for charging the motor boat 8301 can be provided, for example, at mooring facilities for mooring ships in a harbor. Furthermore, the motor boat 8301 can be charged during the moorage of the motor boat 8301.

The use of the configuration disclosed in the embodiment described above allows electric power to be supplied efficiently, even when the electric power transmitting device 8303 is located away from the electric power receiving device 8302. In addition, even when the motor boat 8301 is shaken to change the distance between the electric power transmitting device 8303 and the electric power receiving device 8302, electric power can be supply efficiently.

FIG. 8B shows a configuration of an electric wheelchair 8311 as one of moving objects according to the present invention. FIG. 8B illustrates, as an example, a case of the electric wheelchair 8311 including in its back an electric power receiving device 8312. Furthermore, FIG. 8B shows, as an example, a case of providing an electric power transmitting device 8313 for charging the electric wheelchair 8311 in a facility for using or storing the electric wheelchair 8311.

The use of the configuration disclosed in the embodiment described above allows electric power to be supplied efficiently, even when the electric power transmitting device 8313 is located away from the electric power receiving device 8312. In addition, even when the distance between the electric power transmitting device 8313 and the electric power receiving device 8312 is changed, electric power can be supply efficiently.

### Embodiment 4

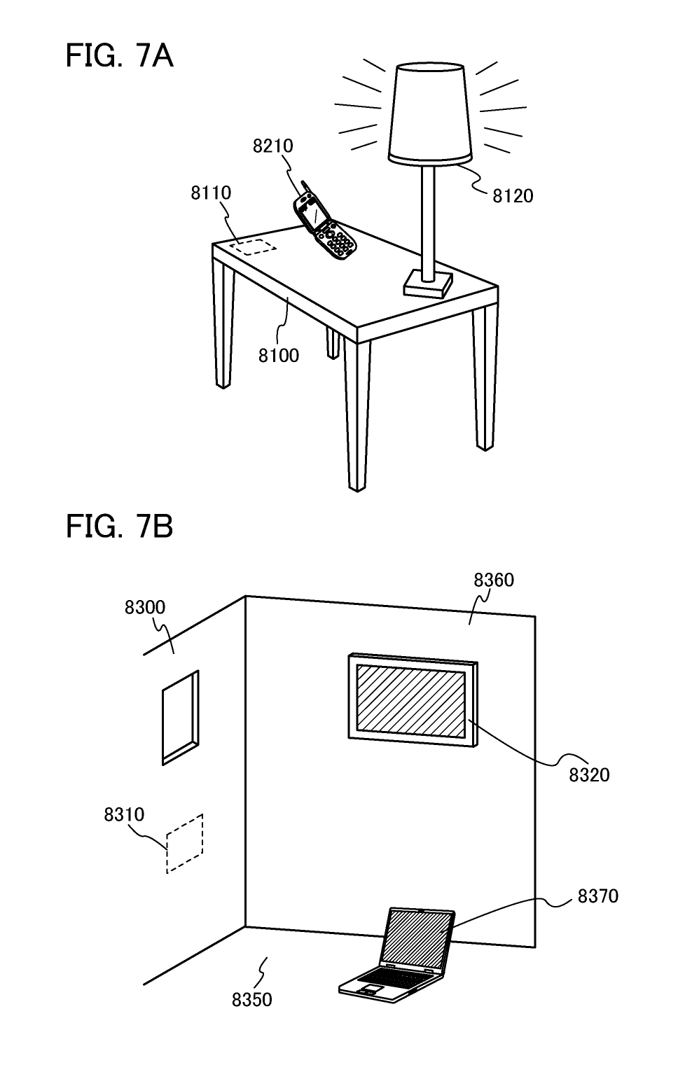

In the present embodiment, examples of utility forms of the electric power receiving device shown in the embodiment described above will be described with reference to FIGS. 7A and 7B.

FIG. 7A shows an example of providing a table 8100 with an electric power transmitting device 8110. The electric power transmitting device is not necessarily provided in the uppermost part of the tabletop, and can be provided inside the tabletop or under the tabletop. More specifically, the electric power transmitting device can be provided without marring the appearance of the table 8100.

A table lamp 8120 placed on the table 8100 includes the electric power receiving device, which receives electric power transmitted from the electric power transmitting device 8110, thereby allowing the lamp to be lighted. The use of the configuration disclosed in the embodiment described above allows electric power to be supplied efficiently, even in locations away from the electric power transmitting device 8110. Thus, the table lamp 8120 can be lighted without taking into consideration a power code. In addition, even when the distance between the electric power transmitting device 8110 and the table lamp 8120 is changed, electric power can be supplied efficiently, and the table lamp 8120 can be thus lighted in any location.

In addition, the electric power transmitting device 8110 can charge a storage battery built in a cellular phone 8210, even when the cellular phone 8210 including the electric power receiving device is located away from the electric power transmitting device 8110. The cellular phone 8210 is more easily provided with a waterproof function, etc., because it is not necessary to provide the mobile phone 8210 with any electrical contact. In addition, even when the distance between the electric power transmitting device 8110 and the cellular phone 8210 is changed, electric power can be supplied efficiently, and the cellular phone 8210 can be thus charged in any location.

FIG. 7B shows an example of placing an electric power transmitting device 8310 in a wall 8300. The electric power transmitting device can be provided not only in the wall but also on the floor and in the ceiling, and the electric power transmitting device 8310 can be provided without marring the appearance of the room interior.

A television 8320 placed on the wall 8360 includes the electric power receiving device, which receives electric power transmitted from the electric power transmitting device 8310 provided in the wall 8300, thereby allowing images to be displayed. The use of the configuration disclosed in the embodiment described above allows electric power to be supplied efficiently, even in locations away from the electric power transmitting device 8310. In addition, even when the distance between the electric power transmitting device 8310 and the television 8320 is changed, electric power can be supplied efficiently, and the television 8320 can be thus placed in any location to display images.

A laptop computer 8370 placed on the floor 8350 includes the electric power receiving device, which receives electric power transmitted from the electric power transmitting device 8310, thereby allowing the laptop computer 8370 to operate and allowing a built-in battery to be charged. The use of the configuration disclosed in the embodiment described above allows electric power to be supplied efficiently, even in locations away from the electric power transmitting device 8310. In addition, even when the distance between the electric power transmitting device 8310 and the laptop computer 8370 is changed, electric power can be supplied efficiently, and the laptop computer 8370 can be thus operated in any location.

The present embodiment can be implemented in combination with the embodiments described above as appropriate.

This application is based on Japanese Patent Application serial no. 2010-138112 filed with Japan Patent Office on Jun. 17, 2010, the entire contents of which are hereby incorporated by reference.

What is claimed is:

1. An electric power transmitting device comprising;
an electric power radiation circuit comprising an antenna and a variable resistive element; and
a modulated signal detection circuit configured to change a resistance value of the variable resistive element in order to change a Q value of the electric power radiation circuit.

2. The electric power transmitting device according to claim 1, further comprising a power source for supplying high-frequency power to the electric power radiation circuit.

3. The electric power transmitting device according to claim 1, wherein the antenna comprises a coiled antenna.

4. An electric power receiving device comprising: a resonance circuit, a modulation circuit including a transistor, and a logic circuit,
wherein the logic circuit is connected to a gate of the transistor included in the modulation circuit, and
wherein a switching operation for the transistor is configured to change an impedance of the resonance circuit.

5. The electric power receiving device according to claim 4, wherein the resonance circuit comprises a coiled antenna.

6. A method for supplying electric power, the method using an electric power transmitting device comprising a power source for supplying an alternating-current power with a first frequency, a modulated signal detection circuit, and an electric power radiation circuit including an antenna and a variable resistive element; and an electric power receiving device comprising a resonance circuit and a modulation circuit, the method comprising:
fluctuating an impedance of the resonance circuit at a second frequency by the modulation circuit to generate a reflected wave with the second frequency in the electric power transmitting device,
detecting an amplitude of the second frequency by the modulated signal detection circuit, and
changing a resistance value of the variable resistive element depending on a magnitude of the amplitude.

7. The method for supplying electric power according to claim 6, wherein the first frequency and the second frequency are different from each other.
